(19) United States
(12) Patent Application Publication
(10) Pub. No.: US 2026/0030934 A1
(43) Pub. Date: Jan. 29, 2026

(54) OUTSIDE PROMPT SOUND OUTPUTTING METHOD AND APPARATUS, DEVICE, AND READABLE STORAGE MEDIUM

(71) Applicant: AAC Acoustic Technologies (Shanghai) Co., Ltd., Shanghai (CN)

(72) Inventors: Wanli Xu, Shanghai (CN); Xuejing Sun, L.A., CA (US)

(21) Appl. No.: 18/988,947

(22) Filed: Dec. 20, 2024

Related U.S. Application Data
(63) Continuation of application No. PCT/CN2024/107624, filed on Jul. 25, 2024.

(51) Int. Cl. G07C 5/02; B60Q 5/00; G08B 3/00

(52) U.S. Cl. CPC G07C 5/02; B60Q 5/00; G08B 3/00

(57) ABSTRACT

The present disclosure provides an outside prompt sound outputting method and apparatus, a device, and a readable storage medium. An outside prompt sound master tape is obtained, and frequency conversion processing is performed on the outside prompt sound master tape to obtain processed audio samples; corresponding target loudness information is obtained based on a current driving speed of a vehicle; a simulated vehicle driving sound wave audio is generated by combining the processed audio samples with the target loudness information. A vehicle driving prompt sound outputting instruction is generated based on the simulated vehicle driving sound wave audio, and the vehicle driving prompt sound outputting instruction is transmitted to an external vehicle loudspeaker. An external loudspeaker of a new energy vehicle is used to simulate and output a vehicle driving prompt sound to the outside, thereby improving the traffic safety of a driving environment of the new energy vehicle.

### CROSS-REFERENCE TO RELATED APPLICATIONS

This application is a continuation of International Application No. PCT/CN2024/107624, filed on Jul. 25, 2024, the entire content of which is incorporated herein by reference.

### TECHNICAL FIELD

The present application relates to the technical field of speech processing, which can be applied to a virtual driving sound wave outputting scenario of new energy vehicles. Specifically, the present application relates to an outside prompt sound outputting method and apparatus, a device, and a readable storage medium.

### BACKGROUND

In the era of fuel vehicles, an engine noise reduction capability is one of important factors that affect environmental noise and vehicle comfort, but new energy vehicles do not have the problem of high motor noise. On the contrary, the new energy vehicles may have problems caused by too low noise. A significant problem is that it is difficult for pedestrians to perceive the new energy vehicles running when the new energy vehicles are at low speeds. In practical applications, in mixed traffic environments such as residential areas and campuses where people and vehicles are not separated, or on narrow roads, when a new energy vehicle that is driven at a low speed approaches a pedestrian, the pedestrian may not perceive the vehicle due to its too low noise. Especially at a road intersection and in a specific situation where visually impaired people or even blind people walk, there is a possibility of danger.

It is worth noting that the technologies described in this section may not necessarily be technologies that have been previously envisioned or used. Unless otherwise specified, it should not be assumed that any technology described in this section is considered to be an existing technology simply because it is included in this section. Similarly, unless otherwise specified, the issues mentioned in this section should not be considered to be recognized in any existing technology.

### SUMMARY

The present disclosure provides an outside prompt sound outputting method and apparatus, a device, and a readable storage medium designed to solve at least to some extent one of the problems in the related technology.

In order to solve the technical problem, in the first aspect, the present disclosure provides an outside prompt sound outputting method, including: obtaining an outside prompt sound master tape, and performing frequency conversion processing on the outside prompt sound master tape to obtain processed audio samples. Obtaining corresponding target loudness information based on a current driving speed of a vehicle. Generating a simulated vehicle driving sound wave audio by combining the processed audio samples with the target loudness information. Generating a vehicle driving prompt sound outputting instruction based on the simulated vehicle driving sound wave audio, and transmitting the vehicle driving prompt sound outputting instruction to an external vehicle loudspeaker, wherein the vehicle driving prompt sound outputting instruction is used for instructing the external vehicle loudspeaker to output the simulated vehicle driving sound wave audio.

In the second aspect, the present disclosure provides an outside prompt sound outputting apparatus, including: a sample obtaining module, configured to: obtain an outside prompt sound master tape, and perform frequency conversion processing on the outside prompt sound master tape to obtain processed audio samples. A loudness obtaining module, configured to obtain corresponding target loudness information based on a current driving speed of a vehicle. An audio generation module, configured to generate a simulated vehicle driving sound wave audio by combining the processed audio samples with the target loudness information; and an outputting control module, configured to generate a vehicle driving prompt sound outputting instruction based on the simulated vehicle driving sound wave audio, and transmit the vehicle driving prompt sound outputting instruction to an external vehicle loudspeaker, wherein the vehicle driving prompt sound outputting instruction is used for instructing the external vehicle loudspeaker to output the simulated vehicle driving sound wave audio.

In the third aspect, the present disclosure provides an electronic device, which include a memory and a processor.

The processor is configured to run a computer program stored on the memory. When running the computer program, implements the steps in the outside prompt sound outputting method as described in the first aspect.

In the fourth aspect, the present disclosure provides a computer-readable storage medium, having a computer program stored thereon, wherein the computer program, when run by a processor, implements the steps in the outside prompt sound outputting method as described in the first aspect.

As can be seen from the above, the present disclosure provides an outside prompt sound outputting method and apparatus, a device, and a readable storage medium. An outside prompt sound master tape is obtained, and frequency conversion processing is performed on the outside prompt sound master tape to obtain processed audio samples; corresponding target loudness information is obtained based on a current driving speed of a vehicle; a simulated vehicle driving sound wave audio is generated by combining the processed audio samples with the target loudness information; and a vehicle driving prompt sound outputting instruction is generated based on the simulated vehicle driving sound wave audio, and the vehicle driving prompt sound outputting instruction is transmitted to an external vehicle loudspeaker. Through the implementation of the present application, an external loudspeaker of a new energy vehicle is used to simulate and output a vehicle driving prompt sound to the outside, so that people near the vehicle can effectively know an approaching behavior of the vehicle, thereby improving the traffic safety of a driving environment of the new energy vehicle.

It should be understood that the content described in this section is not intended to identify the key or important features of the present application, and is not intended to limit the scope of the present application. Other features of the present application will be easily understood through the following specification.

### BRIEF DESCRIPTION OF THE DRAWINGS

The accompanying drawings exemplarily show embodiments and form a part of this specification, and are combined with the textual description of this specification to explain exemplary implementations of the embodiments. The accompanying drawings shown are for illustrative purposes only and do not limit the scope of the claims. In all accompanying drawings, the same reference numerals represent similar but not necessarily identical elements.

FIG. 1 is a schematic diagram of a hardware architecture of a vehicle-mounted system according to an embodiment of the present application;

FIG. 2 is a basic flowchart of an outside prompt sound outputting method according to an embodiment of the present application;

FIG. 3 is a schematic diagram of a relevance between a speed and a pitch according to an embodiment of the present application;

FIG. 4 is a schematic diagram of a relevance between a speed and loudness according to an embodiment of the present application;

FIG. 5 is a schematic diagram of proportions of frequency bands at different speeds according to an embodiment of the present application;

FIG. 6 is a detailed flowchart of an outside prompt sound outputting method according to an embodiment of the present application;

FIG. 7 is a schematic diagram of functional modules of an outside prompt sound outputting apparatus according to an embodiment of the present application; and

FIG. 8 is a schematic structural diagram of hardware of an electronic device according to an embodiment of the present application.

### DETAILED DESCRIPTION OF THE EMBODIMENTS

To make the aforementioned objectives, features, and advantages of the present disclosure more comprehensible, the accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

In the description of the embodiments of the present application, the terms “first” and “second” are only used for descriptive purposes and cannot be understood as indicating or implying relative importance or implying the number of technical features indicated. Therefore, features defined by “first” and “second” may explicitly or implicitly include one or more of the features. The meaning of the term “plurality” is two or more, unless otherwise specifically limited. The term “include” indicates existence of the described features, wholes, steps, operations, elements, and/or components, but does not exclude existence or addition of one or more other features, wholes, steps, operations, elements, components, and/or sets thereof. The term “and/or” describes an association relationship of associated objects, indicating that there can be three types of relationships. For example, A and/or B can include situations where A exists alone, A and B exist simultaneously, or B exists alone. The character “/” generally indicates that front and after associated objects belong to an “or” relationship.

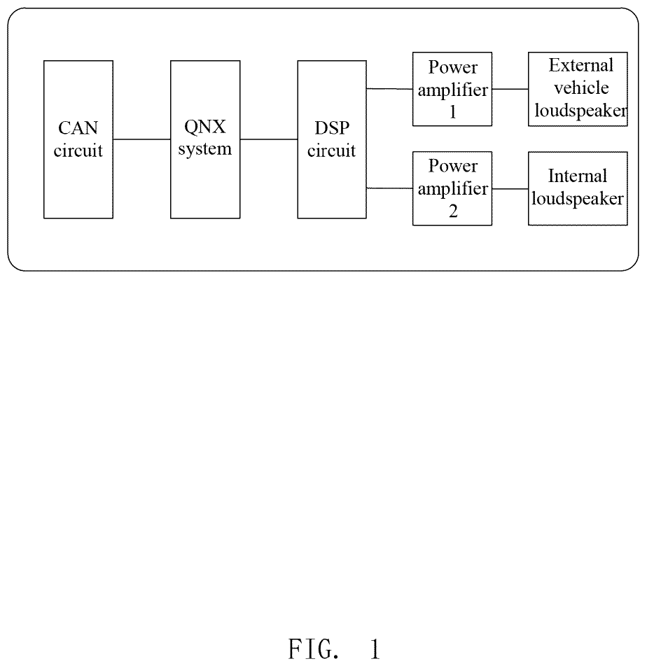

To solve the problem of low traffic safety in a driving environment of new energy vehicles due to a low perception ability of pedestrians for a new energy vehicle running nearby in the related technology, an embodiment of the present application provides an outside prompt sound outputting method that can be applied to a vehicle-mounted system of a new energy vehicle, preferably an Acoustic Vehicle Alerting System (AVAS) system. FIG. 1 is a schematic diagram of a hardware architecture of a vehicle-mounted system according to this embodiment. The system includes a Controller Area Network (CAN) circuit, a Quick UNIX (QXN) system, a Digital Signal Processor (DSP) circuit, a power amplifier, and a loudspeaker which are electrically connected in sequence. It is worth mentioning that, in this embodiment, an AVAS engine that performs a simulated vehicle driving sound wave audio generation process in the above outside prompt sound outputting method and an outside prompt sound master tape used as an engine input are stored in the QNX system. The CAN bus is configured to obtain a current driving speed of a vehicle in real time. The AVAS engine of the QNX system generates a simulated vehicle driving sound wave audio based on the current driving speed of the vehicle and the outside prompt sound master tape. The DSP circuit optimizes the simulated vehicle driving sound wave audio and further transmits a vehicle driving prompt sound outputting instruction to a backend to control an external vehicle loudspeaker to output the simulated vehicle driving sound wave audio. An optimization mode of the DSP circuit includes but is not limited to any one or more of equalization, dynamic control, gain control, and delay control.

It is worth noting that the DSP circuit is provided with two audio signal output ends. One audio signal output end is connected to a multimedia sound output circuit to connect an inside audio power amplifier and a loudspeaker, and the other audio signal output end is connected to an outside audio power amplifier and an AVAS loudspeaker. Therefore, in practical applications, outside driving prompt sound and an inside multimedia sound can be output independently from different loudspeakers, without affecting each other.

It should also be noted that this embodiment integrates the AVAS engine into the QNX system, which has the advantages of high integration, low DSP resource occupation, high sound outputting instantaneity, and low delay when compared with an independently arranged outside driving prompt sound system.

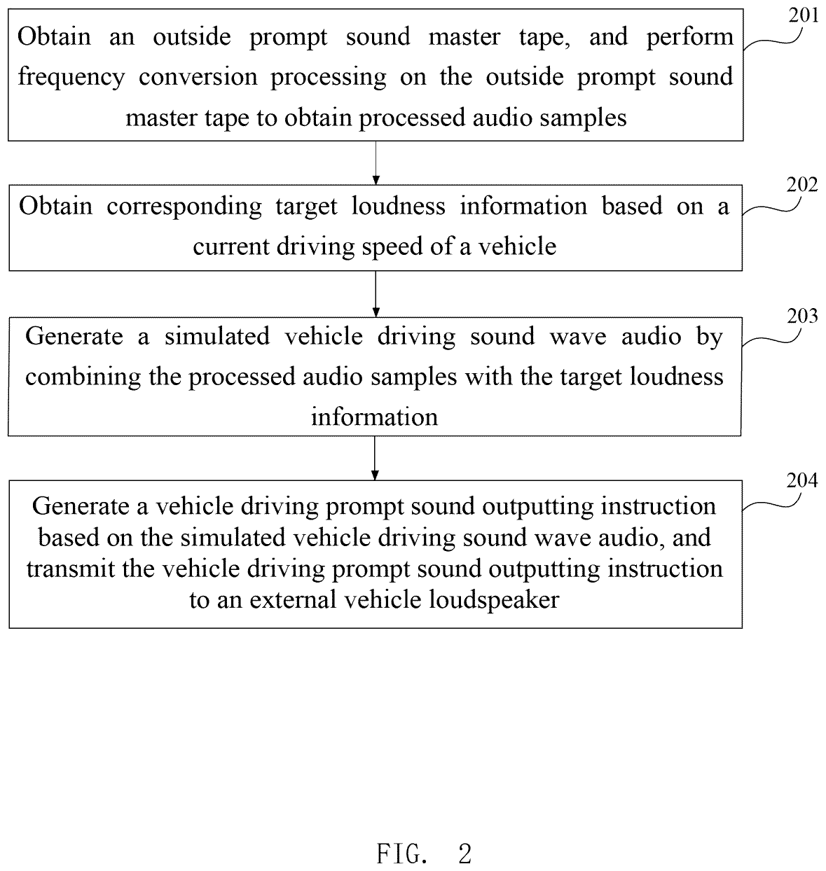

FIG. 2 is a basic flowchart of an outside prompt sound outputting method according to this embodiment. The outside prompt sound outputting method includes the following steps:

Step 201, an outside prompt sound master tape is obtained, and frequency conversion processing is performed on the outside prompt sound master tape to obtain processed audio samples.

Specifically, the outside prompt sound master tape of this embodiment can be an outside prompt sound sample with a specific sound effect, which is stored in a specific database, or an outside driving sound wave audio sample which is recorded in advance for a fuel vehicle. It should be further understood that this embodiment can apply the same outside prompt sound master tape to current driving speeds of different vehicles, or adaptively obtain corresponding outside prompt sound master tapes for current driving speeds of different vehicles.

In some embodiments of this embodiment, the performing frequency conversion processing on the outside prompt sound master tape to obtain processed audio samples includes: Frequency division processing is performed on the outside prompt sound master tape to obtain a plurality of outside prompt sound samples corresponding to different frequency bands; and the frequency conversion processing is separately performed on the plurality of outside prompt sound samples to obtain the processed audio samples.

Specifically, in this embodiment, the frequency division is first performed on the obtained outside prompt sound master tape to obtain the outside prompt sound samples of different frequency bands. The plurality of frequency bands are classified according to different frequency levels, including, for example, an ultra-low frequency band (0 to 300 Hz), a low frequency band (300 to 2500 Hz), a medium frequency band (2500 to 5000 Hz), and a high frequency band (5000 to 10000 Hz). Next, amplitude normalization processing can be further performed on the plurality of outside prompt sound samples after frequency division.

Further, in some implementations of this embodiment, the separately performing the frequency conversion processing on the plurality of outside prompt sound samples to obtain the processed audio samples includes: determining first pitch information and second pitch information which correspond to the current driving speed by respectively using a preset first inverse proportional function and a first direct proportional function; and performing the frequency conversion processing on a first outside prompt sound sample in a first frequency band among all the outside prompt sound samples according to the first pitch information, and performing the frequency conversion processing on a second outside prompt sound sample in a second frequency band among all the outside prompt sound samples according to the second pitch information, to obtain the processed audio samples, where a maximum frequency of the first frequency band is less than or equal to a preset first frequency threshold; a minimum frequency of the second frequency band is greater than a preset second frequency threshold; and the second frequency threshold is greater than or equal to the first frequency threshold.

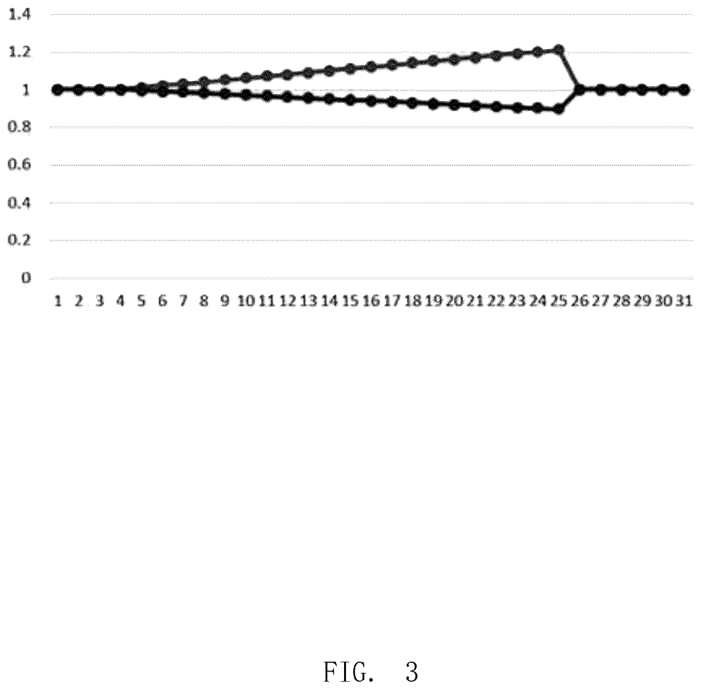

FIG. 3 is a schematic diagram of relevance between a speed and a pitch according to an embodiment of the present application, where the horizontal axis represents speed and the vertical axis represents pitch. This figure illustrates relevances between speeds and pitches of samples in two different frequency bands. A difference from a general processing method for using the same frequency conversion processing for samples in all frequency bands is as follows: In this embodiment, within a specific speed range (e.g. less than 26 km/h in FIG. 3), two different frequency conversion processing methods can be adaptively used for the samples in different frequency bands. The ultra-low frequency band X1, the low frequency band X2, the medium frequency band X3, and the high frequency band X4 mentioned in this embodiment are taken as an example. The corresponding first pitch information can be determined according to a relevance, represented by an inverse proportional function, between a speed and a pitch in FIG. 3, and the frequency conversion processing is performed on the samples in the ultra-low frequency band X1 and the low frequency band X2. The corresponding second pitch information can be determined according to another relevance, represented by a direct proportional function, between a speed and a pitch in FIG. 3, and the frequency conversion processing is performed on the samples in the medium frequency band X3 and the high frequency band X4. In this way, the ductility of a processed sound is improved, thereby avoiding a feeling of jangles and reducing the noise impact on a surrounding environment.

It should be further noted that when the current driving speed of the vehicle exceeds a specific speed threshold (e.g. 26 km/h in FIG. 3), fixed pitch information can be used to perform the same frequency conversion processing on the outside prompt sound samples of all the frequency bands.

Step 202, corresponding target loudness information is obtained based on a current driving speed of a vehicle.

Specifically, this embodiment designs a mechanism for changing loudness with speed to assign different pieces of loudness information to current driving speeds of different vehicles.

In some implementations of this embodiment, the obtaining corresponding target loudness information based on a current driving speed of a vehicle includes: obtaining overall loudness information corresponding to the current driving speed of the vehicle; and respectively determining the target loudness information corresponding to the different frequency bands according to the overall loudness information.

Specifically, in this embodiment, a relevance relationship between the speed and the overall loudness is configured in advance. By using the current driving speed of the vehicle as an independent variable, the overall loudness information serving as a dependent variable can be determined. Then, audio loudness of different frequency bands can be determined according to the overall loudness.

In some implementations of this embodiment, the obtaining overall loudness information corresponding to the current driving speed of the vehicle includes: if the current driving speed is less than or equal to a first speed threshold, determining the overall loudness information corresponding to the current driving speed of the vehicle according to a preset second direct proportional function; if the current driving speed is greater than the first speed threshold and less than or equal to a second speed threshold, determining the overall loudness information corresponding to the current driving speed of the vehicle according to a preset second inverse proportional function; and if the current driving speed is greater than the second speed threshold, determining that the overall loudness information corresponding to the current driving speed of the vehicle is zero.

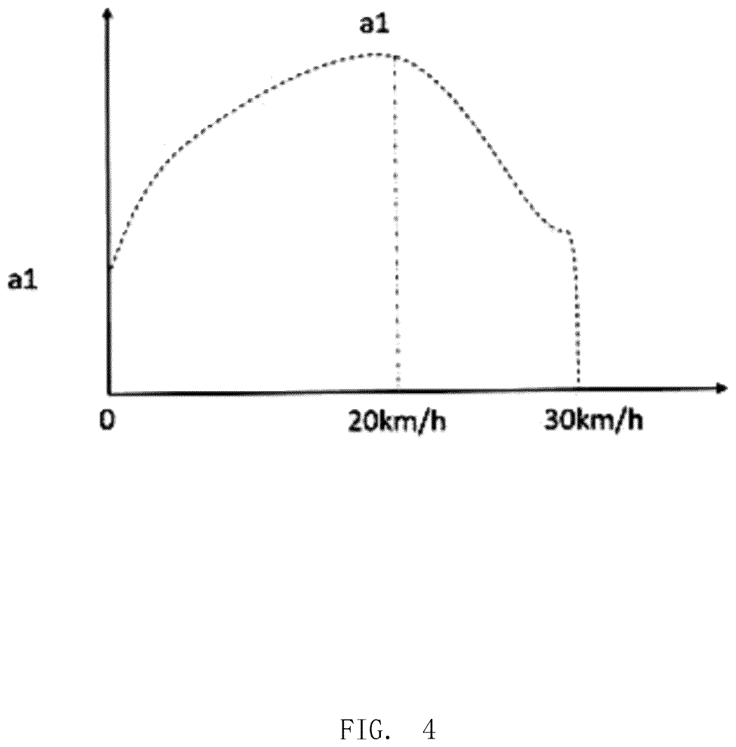

A different from a general processing method for determining the overall loudness information according to a single continuous positive relevance relationship is as follows: In this embodiment, a piecewise function is used to represent relevances between speeds within different speed ranges and the loudness. FIG. 4 is a schematic diagram of a relevance between a speed and loudness according to an embodiment of the present application. Exemplarily, the first speed threshold is set to 20 km/h, and the second speed threshold is set to 30 km/h. When the current driving speed of the vehicle is less than or equal to 20 km/h, the loudness increases with the increase of the speed of the vehicle. When the current driving speed of the vehicle is greater than 20 km/h and less than or equal to 30 km/h, the loudness decreases with the increase of the speed of the vehicle. In addition, when the current driving speed of the vehicle is greater than 30 km/h, the loudness decreases to zero, which is applicable to a pedestrian prompt need in a low-speed driving scenario of a vehicle and avoids noise interference to the surrounding environment in medium and high-speed driving scenarios.

In some implementations of this embodiment, the respectively determining the target loudness information corresponding to the different frequency bands according to the overall loudness information includes: determining sample proportion information of different frequency bands according to the current driving speed of the vehicle; and determining the target loudness information corresponding to the different frequency bands according to the sample proportion information corresponding to the frequency bands and the overall loudness information.

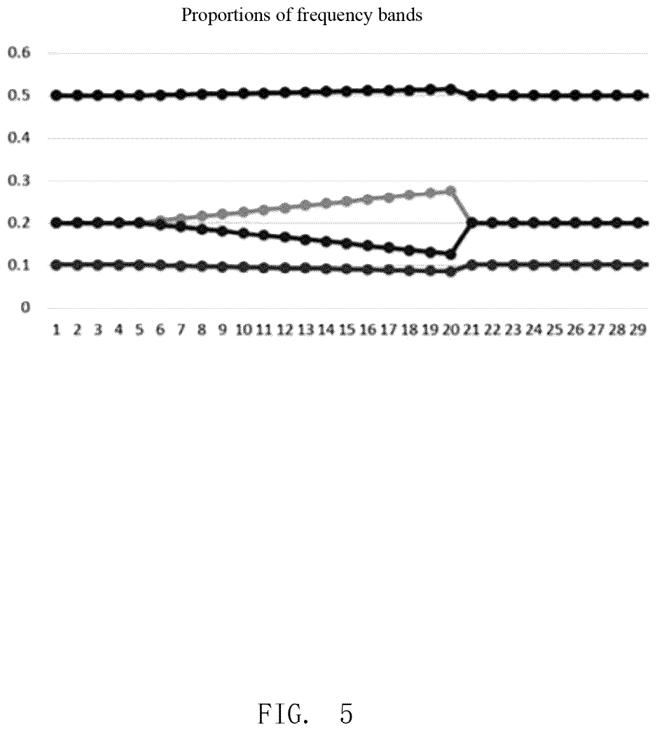

Specifically, this embodiment can adjust proportion relationships of the samples in the frequency bands according to the sample proportion information, and tones generated therefrom may not be limited by the samples. FIG. 5 is a schematic diagram of proportions of frequency bands at different speeds according to this embodiment. In this figure, the horizontal axis represents speed and the vertical axis represents percentage. In this embodiment, the corresponding sample proportion information of different frequency bands at different driving speeds is calibrated in advance. For example, the proportions of the ultra-low frequency band, the low frequency band, the medium frequency band, and the high frequency band are coe1, coe2, coe3, and coe4, respectively, and coe1+coe2+coe3+coe4=1.0. If the overall loudness information is represented as Amp, the loudness information of different frequency bands is Amp1=Amp*coe1, Amp3=Amp*coe2, Amp3=Amp*coe3, and Amp4=Amp*coe4.

It should be noted that FIG. 5 is only an example of the proportion relationships of the frequency bands. In practical applications, the proportions can be flexibly set according to specific application scenarios. For example, if the AVAS loudspeaker has a poor response to the ultra-low frequency band, and energy in this part is high, vibration may be generated, which may damage the loudspeaker. Therefore, the proportion of this frequency band can be minimized as much as possible.

Step 203, a simulated vehicle driving sound wave audio is generated by combining the processed audio samples with the target loudness information.

In a case that the processed audio samples include a plurality of audio samples of different frequency bands, this embodiment performs loudness variation processing on the audio samples of the frequency bands after frequency conversion processing based on the processed audio samples, which satisfy a specific sample proportion relationship, of different frequency bands, and then synthesizes the audio samples, thus generating the simulated vehicle driving sound wave audio that conforms to the current driving speed of the vehicle.

It should be noted that in a process of uniform acceleration or deceleration driving of the vehicle, when the simulated vehicle driving sound wave audio is continuously output, in order to avoid a poor sound effect caused by occurrence of a pop sound, this embodiment further processes the connected simulated vehicle driving sound wave audio. A specific processing method is to fade out a front audio in the connected simulated vehicle driving sound wave audio and fade in a back audio to ensure the continuity of a mixed audio signal in a time domain. By crossover switching between fade in and fade out, the pop sound caused by the discontinuity of the sound effect in the time domain can be effectively avoided.

Step 204, a vehicle driving prompt sound outputting instruction is generated based on the simulated vehicle driving sound wave audio, and the vehicle driving prompt sound outputting instruction is transmitted to an external vehicle loudspeaker.

The vehicle driving prompt sound outputting instruction is used for instructing the external vehicle loudspeaker to output the simulated vehicle driving sound audio, to outputting a simulated audio or a specific vehicle driving sound effect to the outside when a traditional fuel vehicle is in driving, thereby achieving an effect of prompting pedestrians around the vehicle that the vehicle is approaching. It is worth mentioning that a single or a plurality of loudspeakers can be configured outside the vehicle. Each loudspeaker can be arranged at any position such as a body or roof of the vehicle. This embodiment does not impose a unique limitation on a number and positions of the external vehicle loudspeakers.

In some implementations of this embodiment, the vehicle driving prompt sound outputting instruction is output to an external vehicle loudspeaker, which includes: An orientation of a pedestrian is determined based on environment detection data acquired by a sensor of the vehicle; a target external vehicle loudspeaker of a corresponding sound production orientation is determined from the plurality of external vehicle loudspeakers at different configuration positions according to the orientation of the pedestrian; and the vehicle driving prompt sound outputting instruction is transmitted to the target external vehicle loudspeaker.

Specifically, this embodiment can directionally output a vehicle driving prompt sound for the pedestrians around the vehicle. In practical applications, the specific orientation of the pedestrian around the vehicle can be identified according to the detection data of the sensor such as a LiDAR and a camera. After the corresponding sound production orientation is determined according to the orientation of the pedestrian, a single external vehicle loudspeaker located at the sound production orientation can be used as the target external vehicle loudspeaker, or two external vehicle loudspeakers located on two sides of the sound production orientation can be used as the target external vehicle loudspeaker.

In some implementations of this embodiment, the outside prompt sound outputting method further includes: When it is detected that the vehicle is in a reverse state, a preset simulated reverse sound wave audio is obtained, and a reverse prompt sound outputting instruction is generated; and the reverse prompt sound outputting instruction is transmitted to the external vehicle loudspeaker. The vehicle driving prompt sound outputting instruction is used for instructing the external vehicle loudspeaker to output the simulated reverse sound wave audio.

Specifically, a difference from the foregoing outside prompt sound outputting method corresponding to a normal driving state of the vehicle, this embodiment provides an independent outside prompt sound outputting scheme when the vehicle is in the reverse state. The frequency conversion processing and the loudness variation processing do not need to be performed, but the external vehicle loudspeaker is directly controlled to output a preset simulated reverse sound wave audio.

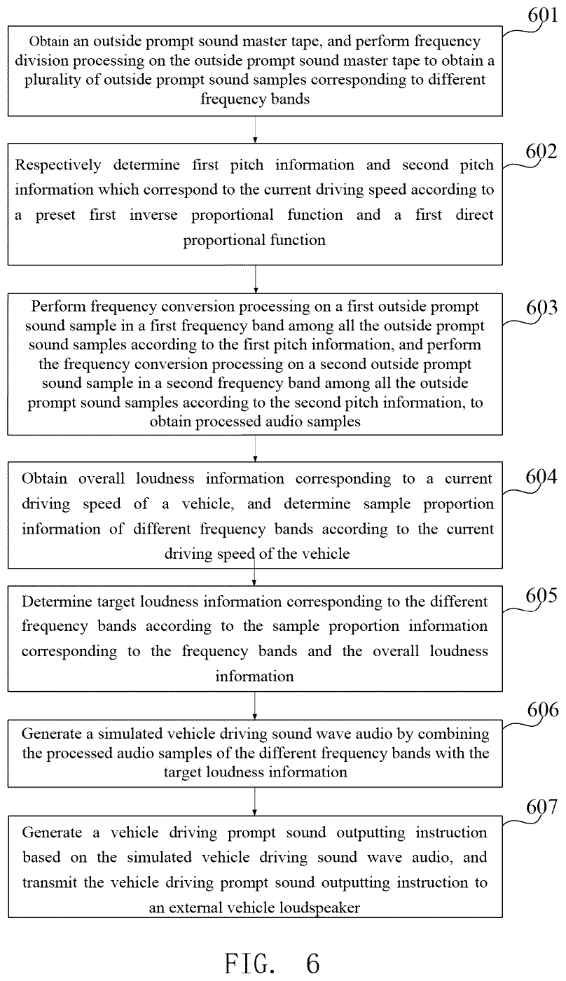

To better illustrate the implementation schemes of the present application, this embodiment further provides a detailed outside prompt sound outputting method. FIG. 6 is a detailed flowchart of an outside prompt sound outputting method according to this embodiment, specifically including the following steps:

Step 601, an outside prompt sound master tape is obtained, and frequency division processing is performed on the outside prompt sound master tape to obtain a plurality of outside prompt sound samples corresponding to different frequency bands;

Step 602, first pitch information and second pitch information which correspond to the current driving speed are determined respectively according to a preset first inverse proportional function and a first direct proportional function;

Step 603, frequency conversion processing is performed on a first outside prompt sound sample in a first frequency band among all the outside prompt sound samples according to the first pitch information, and the frequency conversion processing is performed on a second outside prompt sound sample in a second frequency band among all the outside prompt sound samples according to the second pitch information, to obtain processed audio samples;

Step 604, overall loudness information corresponding to a current driving speed of a vehicle is obtained, and sample proportion information of different frequency bands is determined according to the current driving speed of the vehicle;

Step 605, target loudness information corresponding to the different frequency bands is determined according to the sample proportion information corresponding to the frequency bands and the overall loudness information;

Step 606, a simulated vehicle driving sound wave audio is generated by combining the processed audio samples of the different frequency bands with the target loudness information; and

Step 607, a vehicle driving prompt sound outputting instruction is generated based on the simulated vehicle driving sound wave audio, and the vehicle driving prompt sound outputting instruction is transmitted to an external vehicle loudspeaker.

It should be understood that in this embodiment, serial numbers of the steps do not indicate an execution sequence of the steps, and the execution sequence of the steps should be determined according to functions and internal logics of the steps and should not impose a unique limitation on an implementation process of the embodiments of the present application.

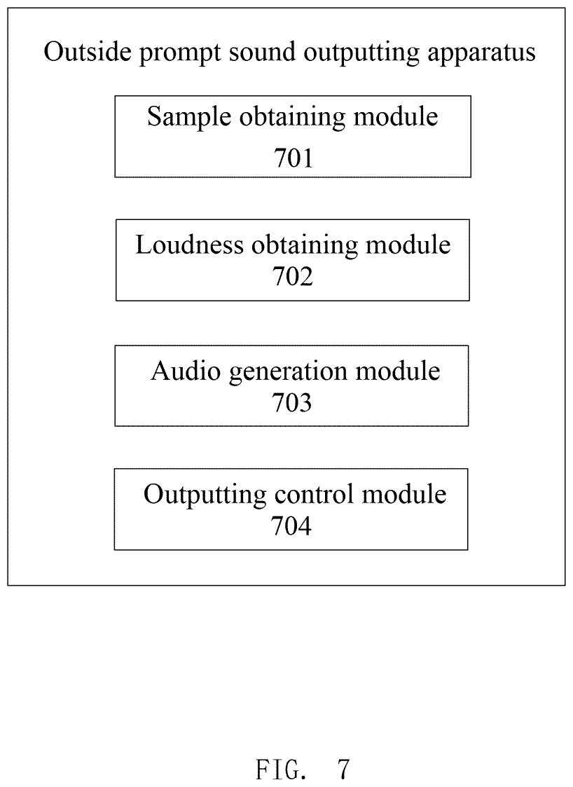

FIG. 7 is a schematic diagram of functional modules of an outside prompt sound outputting apparatus according to an embodiment of the present application. The outside prompt sound outputting apparatus can be configured to implement the outside prompt sound outputting method in the foregoing embodiment. The apparatus mainly includes:
a sample obtaining module 701, configured to: obtain an outside prompt sound master tape, and perform frequency conversion processing on the outside prompt sound master tape to obtain processed audio samples;
a loudness obtaining module 702, configured to obtain corresponding target loudness information based on a current driving speed of a vehicle;
an audio generation module 703, configured to generate a simulated vehicle driving sound wave audio by combining the processed audio samples with the target loudness information; and
an outputting control module 704, configured to generate a vehicle driving prompt sound outputting instruction based on the simulated vehicle driving sound wave audio, and transmit the vehicle driving prompt sound outputting instruction to an external vehicle loudspeaker, where the vehicle driving prompt sound outputting instruction is used for instructing the external vehicle loudspeaker to output the simulated vehicle driving sound wave audio.

In an optional implementation of this embodiment, the above outputting control module is further configured to: when it is detected that the vehicle is in a reverse state, obtain a preset simulated reverse sound wave audio, generate a reverse prompt sound outputting instruction, and transmit the reverse prompt sound outputting instruction to the external vehicle loudspeaker. The vehicle driving prompt sound outputting instruction is used for instructing the external vehicle loudspeaker to output the simulated reverse sound wave audio.

It should be noted that the outside prompt sound outputting methods in the foregoing method embodiments can be implemented based on the outside prompt sound outputting apparatus according to this embodiment. A person of ordinary skill in the art can clearly understand that for the convenience and conciseness of the description, for a specific working process of the outside prompt sound outputting apparatus described in this embodiment, refer to the corresponding working process in the foregoing method embodiments. It will not be elaborated here.

Based on the above technical solutions of the embodiments of the present application, an outside prompt sound master tape is obtained, and frequency conversion processing is performed on the outside prompt sound master tape to obtain processed audio samples; corresponding target loudness information is obtained based on a current driving speed of a vehicle; a simulated vehicle driving sound wave audio is generated by combining the processed audio samples with the target loudness information; and a vehicle driving prompt sound outputting instruction is generated based on the simulated vehicle driving sound wave audio, and the vehicle driving prompt sound outputting instruction is transmitted to an external vehicle loudspeaker. Through the implementation of the present application, an external loudspeaker of a new energy vehicle is used to simulate and output a vehicle driving prompt sound to the outside, so that people near the vehicle can effectively know an approaching behavior of the vehicle, thereby improving the traffic safety of a driving environment of the new energy vehicle.

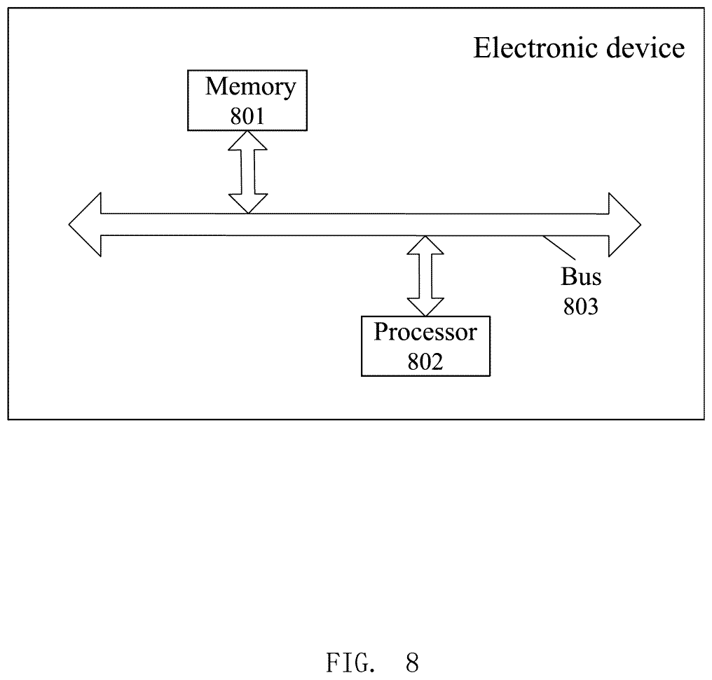

Referring to FIG. 8, FIG. 8 is an electronic device according to an embodiment of the preset application. The electronic device can be applied to implementing the outside prompt sound outputting method in the foregoing embodiment. As shown in FIG. 8, the electronic device mainly includes:

a memory 801, a processor 802, and a bus 803. The memory 801 and the processor 802 are connected through the bus 803. The memory 801 stores a computer program runnable on the processor 802. The processor 802, when running the computer program, implements the outside prompt sound outputting method in the foregoing embodiment. There may be one or more processors.

The memory 801 may be a high-speed Random Access Memory (RAM), or may be a non-volatile memory, for example, a magnetic disk memory. The memory 801 is configured to store executable program codes. The processor 802 is coupled with the memory 801.

Further, the embodiments of the present application further provides a computer-readable storage medium. The computer-readable storage medium may be set in the electronic device in the above embodiments or may be the memory in the foregoing embodiment shown in FIG. 8.

The computer-readable storage medium has a computer program stored thereon. The program, when run by a processor, implements the outside prompt sound outputting method in the foregoing embodiments. Further, the computer-readable storage medium may be: various media that can store program codes, such as a USB flash drive, a mobile hard disk drive, a Read-Only Memory (ROM), a RAM, a magnetic disk, and a compact disc.

In the several embodiments provided in the present application, it should be understood that the disclosed apparatus and method are achieved in other manners. For example, the above-described apparatus embodiment is merely illustrative. For example, the division of the modules is only one type of logical functional division, and other divisions is achieved in practice. For example, multiple modules or components can be combined or integrated into another system, or some features can be omitted, or not executed. In addition, the shown or discussed mutual coupling or direct coupling or communication connection is an indirect coupling or communication connection through some interfaces, apparatuses or modules, and is in an electrical, mechanical or another form.

The modules described as separate parts may or may not be physically separate, and parts displayed as modules may or may not be physical modules, may be located in one position, or may be distributed on a plurality of network modules. Some or all of the modules are selected according to actual needs to achieve the objective of the solution of this embodiment.

In addition, functional modules in embodiments of the present application may be integrated into one processing module, or each of the modules may exist alone physically, or two or more modules are integrated into one module. The integrated modules mentioned above can be implemented in both a hardware form and a software functional module form.

When the integrated module is implemented in the form of a software functional module and sold or used as an independent product, the integrated module may be stored in a computer-readable storage medium. Based on such an understanding, the technical solutions of the present application essentially, or the part contributing to the existing technology, or all or some of the technical solutions may be implemented in the form of a software product. The computer software product is stored in a readable storage medium and includes several instructions for instructing a computer device (which may be a personal computer, a server, a network device, or the like) to execute all or some of the steps of the methods described in the embodiments of the present application. The aforementioned readable storage media include: various media that can store program codes, such as a USB flash disk, a mobile hard disk drive, a ROM, a RAM, a magnetic disk, and a compact disc.

It should be noted that for the aforementioned method embodiments, for the sake of simplicity, they are all described as a series of action combinations. However, those skilled in the art should be aware that the present application is not limited by the order of the described actions, as according to the present application, certain steps can be performed in other orders or simultaneously. Secondly, those skilled in the art should also be aware that the embodiments described in this specification are all preferred embodiments, and the actions and modules involved may not be necessary for the present application.

In the foregoing embodiments, the description of each embodiment has respective focuses. For a part that is not described in detail in an embodiment, reference may be made to related descriptions in other embodiments.

The above content describes the outside prompt sound outputting method and apparatus, the device, and the readable storage medium according to the present application. A person skilled in the art can make changes to specific implementations and the application scope according to the ideas of the embodiments of the present application. In summary, the content of this specification should not be understood as a limitation on the present application.

What is claimed is:

1. An outside prompt sound outputting method, comprising:
obtaining an outside prompt sound master tape, and performing frequency conversion processing on the outside prompt sound master tape to obtain processed audio samples;
obtaining corresponding target loudness information based on a current driving speed of a vehicle;
generating a simulated vehicle driving sound wave audio by combining the processed audio samples with the target loudness information; and
generating a vehicle driving prompt sound outputting instruction based on the simulated vehicle driving sound wave audio, and transmitting the vehicle driving prompt sound outputting instruction to an external vehicle loudspeaker, wherein the vehicle driving prompt sound outputting instruction is used for instructing the external vehicle loudspeaker to output the simulated vehicle driving sound wave audio.

2. The outside prompt sound outputting method according to claim 1, wherein the performing frequency conversion processing on the outside prompt sound master tape to obtain processed audio samples comprises:
performing frequency division processing on the outside prompt sound master tape to obtain a plurality of outside prompt sound samples corresponding to different frequency bands; and
separately performing the frequency conversion processing on the plurality of outside prompt sound samples to obtain the processed audio samples.

3. The outside prompt sound outputting method according to claim 2, wherein the separately performing the frequency conversion processing on the plurality of outside prompt sound samples to obtain the processed audio samples comprises:
determining first pitch information and second pitch information which correspond to the current driving speed by respectively using a preset first inverse proportional function and a first direct proportional function; and
performing the frequency conversion processing on a first outside prompt sound sample in a first frequency band among all the outside prompt sound samples according to the first pitch information, and performing the frequency conversion processing on a second outside prompt sound sample in a second frequency band among all the outside prompt sound samples according to the second pitch information, to obtain the processed audio samples, wherein a maximum frequency of the first frequency band is less than or equal to a preset first frequency threshold; a minimum frequency of the second frequency band is greater than a preset second frequency threshold; and the second frequency threshold is greater than or equal to the first frequency threshold.

4. The outside prompt sound outputting method according to claim 2, wherein the obtaining corresponding target loudness information based on a current driving speed of a vehicle comprises:
obtaining overall loudness information corresponding to the current driving speed of the vehicle; and
respectively determining the target loudness information corresponding to the different frequency bands according to the overall loudness information.

5. The outside prompt sound outputting method according to claim 4, wherein the obtaining overall loudness information corresponding to the current driving speed of the vehicle comprises:
if the current driving speed is less than or equal to a first speed threshold, determining the overall loudness information corresponding to the current driving speed of the vehicle according to a preset second direct proportional function;
if the current driving speed is greater than the first speed threshold and less than or equal to a second speed threshold, determining the overall loudness information corresponding to the current driving speed of the vehicle according to a preset second inverse proportional function; and
if the current driving speed is greater than the second speed threshold, determining that the overall loudness information corresponding to the current driving speed of the vehicle is zero.

6. The outside prompt sound outputting method according to claim 4, wherein the respectively determining the target loudness information corresponding to the different frequency bands according to the overall loudness information comprises:
determining sample proportion information of different frequency bands according to the current driving speed of the vehicle; and
determining the target loudness information corresponding to the different frequency bands according to the sample proportion information corresponding to the frequency bands and the overall loudness information.

7. The outside prompt sound outputting method according to claim 1, further comprising:
when it is detected that the vehicle is in a reverse state, obtaining a preset simulated reverse sound wave audio and generating a reverse prompt sound outputting instruction, and transmitting the reverse prompt sound outputting instruction to the external vehicle loudspeaker, wherein the vehicle driving prompt sound outputting instruction is used for instructing the external vehicle loudspeaker to output the simulated reverse sound wave audio.

8. An outside prompt sound outputting apparatus, comprising:
a sample obtaining module, configured to: obtain an outside prompt sound master tape, and perform frequency conversion processing on the outside prompt sound master tape to obtain processed audio samples;
a loudness obtaining module, configured to obtain corresponding target loudness information based on a current driving speed of a vehicle;
an audio generation module, configured to generate a simulated vehicle driving sound wave audio by combining the processed audio samples with the target loudness information; and
an outputting control module, configured to generate a vehicle driving prompt sound outputting instruction based on the simulated vehicle driving sound wave audio, and transmit the vehicle driving prompt sound outputting instruction to an external vehicle loudspeaker, wherein the vehicle driving prompt sound outputting instruction is used for instructing the external vehicle loudspeaker to output the simulated vehicle driving sound wave audio.

9. An electronic device, comprising: a memory and a processor,
wherein the processor is configured to run a computer program stored on the memory; and
the processor, when running the computer program, implements the steps in the outside prompt sound outputting method according to claim 1.
